(19) United States
(12) Patent Application Publication
(10) Pub. No.: US 2013/0132468 A1
(43) Pub. Date: May 23, 2013

(54) DISCOVERING, ORGANIZING, ACCESSING AND SHARING INFORMATION IN A CLOUD ENVIRONMENT

(71) Applicants: Olurotimi Azeez, Gahanna, OH (US); Sheyi Azeez, Lewis Center, OH (US); Shola Azeez, Westerville, OH (US)

(72) Inventors: Olurotimi Azeez, Gahanna, OH (US); Sheyi Azeez, Lewis Center, OH (US); Shola Azeez, Westerville, OH (US)

(21) Appl. No.: 13/683,881

(22) Filed: Nov. 21, 2012

Related U.S. Application Data
(60) Provisional application No. 61/562,522, filed on Nov. 22, 2011.

(51) Int. Cl. G06F 15/16

(52) U.S. Cl. 709/203

(57) ABSTRACT

A system of providing a single secure site for a user to discover, access, view and manage a plurality of resources. The method includes a decision engine that offers resources to the user based on the user information. The method creates and stores a list of updateable resources based on the user information and queries. The system opens and establishes secure sessions to the websites designated by the user at a webtop without a second sign-on. The system provides the ability for a user to share resources with other like-minded users.

### FIELD OF THE INVENTION

The invention relates to a system and method for discovering, organizing, accessing and sharing information in a cloud computing environment.

### BACKGROUND OF THE INVENTION

Web browsers are commonly used to access the Internet. A web browser provides access to a vast amount and variety of information. Users typically have difficulties in discovering specific information using existing Internet search engines. Without a sort mechanism, access to stored information—even from a single source—is overwhelming. Because of the massive volumes of data available, direct hands-on analysis is now almost always augmented with some level of automated data-manipulation techniques, such as neural networks, clustering, algorithms, decision trees, and support vector machines.

In social networking, the time required to discover others that share common interests is sometimes prohibitive. An improved method of searching and interfacing users to social sites on the Internet would enhance access to information and information sharing among users.

Cloud computing is rapidly becoming the accepted way of accessing data. Cloud computing allows a virtualized platform for Internet-based software, infrastructure and/or services. Cloud computing is highly scalable, convenient, and offers on-demand access to a shared pool of IT resources. Cloud computing allows sharing of traditional computing resources and data through data mining, which is the process of extracting patterns from data.

Cloud computing can be public, private or a mixture. Cloud computing service offerings are Platform-as-a-Service (Paas): An environment that supports online access and collaboration without the necessary investment in hardware; Infrastructure-as-a-Service (IaaS): A comprehensive computer infrastructure (servers, storage, software and networks) made accessible to users via the Internet; Software-as-a-Service (SaaS): Software applications accessible via the Internet; and Desktop-as-a-Service (DaaS): Desktop virtualization including operating system interfaces and built-in storage hardware. Cloud computing is based on grid computing. Grid computing links disparate computers into an infrastructure to tap unused resources. Cloud computing uses grid computing to provision on-demand resources.

Cloud computing provides mass data storage capacity. Computing and storage size work together to improve system efficiency and scalability. The cloud server generally processes complex calculations while mobile terminals are responsible for interaction with users. The cloud collects, indexes, searches, and manages data. Monitoring and management solutions are used to bridge the gap between the physical layer of the data infrastructure and the IT infrastructure (actual compute, storage and communications activity).

While cloud computing has increased the ability to collect, store, access, and manipulate data, the amount of data mining is still limited. No system exists that combines the power of cloud computing with the ability to access favorite websites and analyze and collate real-time information to provide searching and an interface for users in social networking and discovering Internet resources.

### SUMMARY OF THE INVENTION

One aspect of the invention relates to a system and method for providing a cloud-based search engine combining a message-driven mechanism with a grid computing architecture. The system effectively aggregates, correlates and updates data in real-time to provide users with real-time search services. The search engine modifies indexes automatically when logging or modifying information or services. New search results are then returned immediately to insure users can search the latest information the first time.

In an embodiment, the system combines cloud storage services and cloud computing services to classify information and services and build an efficient data distribution mechanism. The system analyzes and provides access to a vast amount of data via a structured format by discovering patterns in the data.

According to an aspect of the invention, the system includes a user interface for directly accessing user-related webpages. The interface incorporates social network sites and other Internet web sites, such as banking, news sources, shopping sites, and the like using a single sign-on.

In an embodiment, the invention presents a dashboard to the user after accessing a website. The dashboard organizes and provides seamless access to secure and unsecure applications. A user creates a secure sign-on at the site. Once logged into the website, the user lists interests picked from categories, such as news websites, auto, shopping, generic, and the like. The user uses the search engine to find interests. In an embodiment, the user drags icons to a folder to create his/her interests list.

According to an aspect of the invention, the system includes a user webtop. The user webtop includes access to webpages associated with the user. The webpages may include a calendar, email account, photo storage, diary, contacts, Internet favorites, and the like.

By using a combination of these features, benefits are ample. For example, users who subscribe to the system can manage affairs, and other users who have already subscribed, thereby expanding the user's referral network, and use the search engine to discover interests.

In an embodiment, the system is a computer-implemented method of providing a single secure site for a user to discover, access, view and manage a plurality of resources on a device, comprising the steps of:

a) receiving and updateably storing at a server after a successful sign-on to the site by the user, user information from a remote terminal connected to the server via the Internet, the user information comprising at least one of a user webpage, an authentication related to the user for a given webpage, a demographic, an interest, and a query;

b) providing a decision engine that offers resources to the user based on the user information;

c) creating and storing a list at the server of updateable resources based on the user information and selected decision engine offers; the resources being at least one of the user's webpages, a targeted webpage, an application, a query answer and software;

d) opening and establishing secure sessions to the resources accessible from the remote terminal that allow the user to access the resources without a second sign-on and wherein each resource is viewed directly by the user on a single webtop and not reopened in a different tab;

e) making any add-ons, such as camera, a microphone, recording features and the like required to view resources available to the device; and

f) providing means for a user to share resources with other like-minded users.

In an embodiment, the resources are at least one of a social, a shopping, a banking, an electronic transfer, a media and an entertainment website. In an embodiment, server is a cloud server. In an embodiment, the resources are housed in a second cloud.

The system provides means for a user to share information via at least one of a blog, a text message and an email. In an embodiment, the site provides a combined inbox of all emails used by a user.

The decision engine ranks offers by categories, including, but not limited to, a hobby, a lifestyle, food, animals, careers, health, sports, and the like.

User information is stored in a profile associated with the user. The profile is updateable by the user. User information may comprise a digital image of the user. The image may be a 3D image. In an embodiment, the resource is an online shopping site and the query is at least one of a fashion style or a cosmetic that is compatible with at least one element of the digital image.

A user may submit a query. The site provides means for the user to set a time limit for the query.

It should be understood that the invention as illustrated in the accompanying drawing figures, is exemplary and may differ in appearance, content, and configuration. Further, and as may be described herein, the terms “log on,” “website,” “page”, and “Internet” are each particular non-limiting examples of generic terms which may comprise any known tool that enables users to select, access, display, and navigate through the various modules of the invention. As used herein “webtop” means a web browser and that integrates various web-based applications, typically lots of different kinds of information feeds (via RSS), virtual office applications, some social software such as Flickr or YouTube, and the like. Webtops are a kind of mashboard where features are coupled with the concept of a dashboard and indicators signal a change regarding the status of changes. The features are configurable and personalized for a user's specified preferences.

Other objects and advantages of the invention will be apparent to those skilled in the art based on the following drawings and detailed description.

### BRIEF DESCRIPTION OF THE DRAWINGS

FIG. 1 is a diagram of an exemplary system showing an aspect of the configuration of the invention.

FIG. 2 is a block diagram of an exemplary system for providing a multi-dimensional contextual platform according to an aspect of the invention.

FIG. 3 illustrates a flow diagram of an exemplary method of information gathering and storage according to an aspect of the invention.

FIG. 4 illustrates a flow diagram of an exemplary method for providing access to selected websites of a user.

FIG. 5 illustrates a flow diagram of an exemplary method for providing adaptive analysis of a search result, according to an aspect of the invention.

FIG. 6 illustrates a flow diagram of an exemplary method for linking collected information to profiles on user dashboards.

FIG. 7 illustrates a flow diagram of an exemplary method for providing access to websites according to an aspect of the invention.

FIG. 8 illustrates a flow diagram of an exemplary method for providing access to secure websites according to an aspect of the invention.

FIG. 9 illustrates a flow diagram of an exemplary method for providing advertisement filtering according to an aspect of the invention.

It should be understood that the appended drawings are not necessarily to scale, presenting a somewhat simplified representation of various preferred features illustrative of the basic principles of the invention. The specific design features of the systems and methods as disclosed herein, including, for example, specific dimensions, orientations, locations, and shapes of the various components, will be determined in part by the particular intended application and use environment.

### DETAILED DESCRIPTION

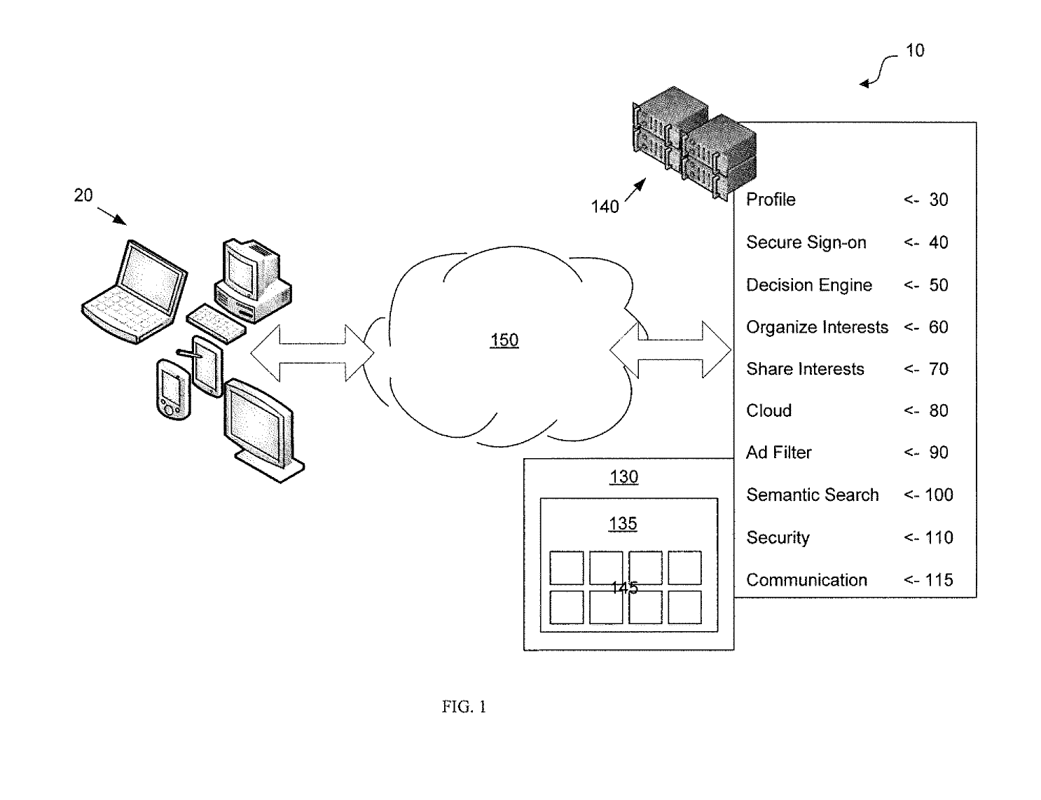

According to an aspect of the invention, FIG. 1 illustrates the structure of the invention. The invention is a cloud-based system 10 that allows users to execute Internet-based applications from a user terminal 20, such as, but not limited to, a personal digital assistant, a tablet, a laptop, a personal computer, workstation, web-enabled mobile phone, smart phone, wireless application protocol device, web-to-voice device, and the like. The terminal 20 includes access and input means, such as a keyboard, keypad, computer mouse, light stylus instrument, touch screen, voice activation and the like. Devices may include add-on, such as, but not limited to, a camera, a microphone, recording features, and the like. Other components, such as printers, etc, may be part of the system. Those having skill in the art will appreciate that the invention described herein may work with various system configurations.

Implementations of the invention may be made in hardware, firmware, software, or any suitable combination thereof. Aspects of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Further, firmware, software, routines, or instructions may be described herein in terms of specific exemplary aspects and implementations of the invention, and performing certain actions. It will be apparent that such descriptions are merely for convenience and that such actions in fact result from computing devices, processors, controllers, or other devices executing the firmware, software, routines, or instructions.

According to an aspect of the invention, a multi-dimensional contextual platform 10 for gathering and disseminating information in a cloud environment is provided. The multi-dimensional contextual platform may be used, among other things, for discovering, organizing and sharing information in a cloud environment. The multi-dimensional contextual platform may comprise an Internet website 130, or other application hosted, for example, on one or more servers 140, which are in the cloud. According to an aspect of the invention, the multi-dimensional contextual platform 10 may be accessible over a network 150, via any wired or wireless communications link, using one or more user terminals 20.

In an embodiment, the system is used by users. The users are individuals, groups and businesses. The system provides the ability for users to place desired Internet websites 145 on a user's webtop 135 at the Internet website 130. The websites are live and not links to the sites.

According to an aspect of the invention, the system 10 comprises the following modules: Profile 30, Single Sign-On 40, Discover Decision Engine 50, Organize Interests 60, Share Interests 70, Cloud 80, Ad Filter 90, Semantic Search 100, Security 110, and Communications 115,

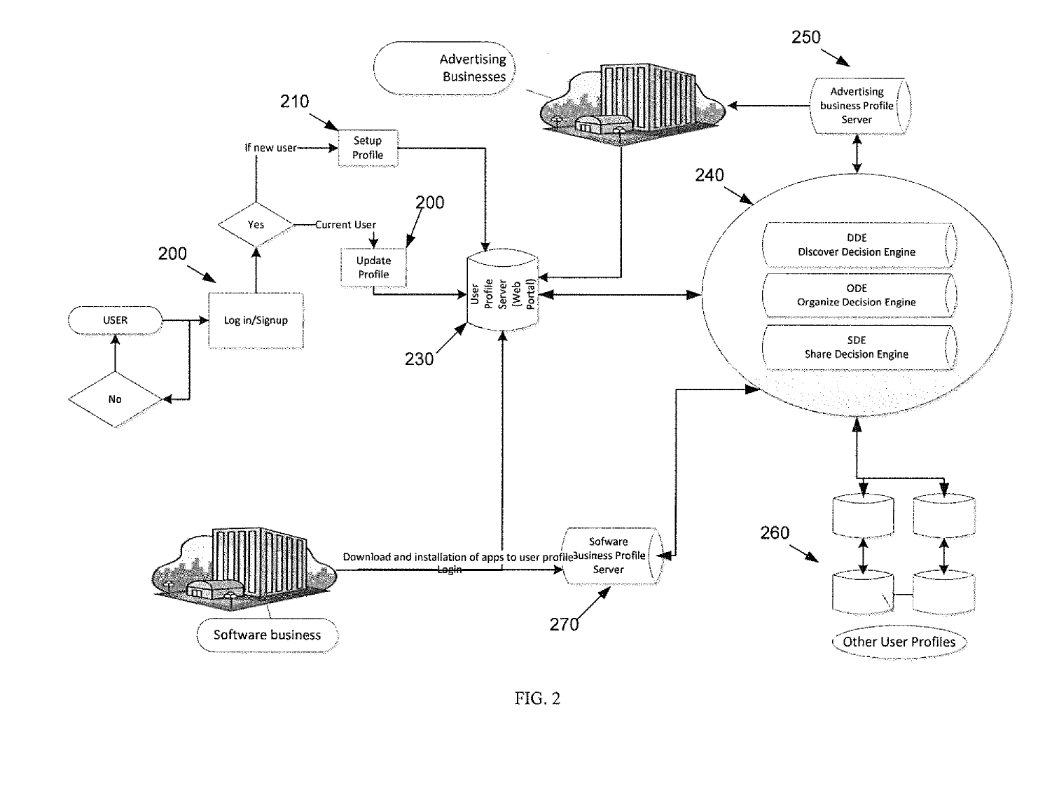

FIG. 2 illustrates a block diagram of the system. A user signs up 200 and creates login information (user name or ID and password) at a setup profile 210. The single sign-on gives authorization information to desired websites 145 using the user's ID and password for that site stored in a database at the Profile 30. The setup can be updated 220, For example, a user can add the Facebook® website to the user's webtop 135. A user may add personal files, such as photos, logos, etc. to that user's profile.

According to an aspect of the invention, the Profile 30 module comprises the following, which may be entered by a user in a fill-in questionnaire: First Name, Last Name, Gender, DOB, email, Location, User Name, Password, and Avatar. The Profile saves data into a Profile database. The user inputs personal data and interest into the personal data section. Interests include hobbies, applications, websites, desired products and services and the like. The Profile module requests interests, which may be on a separate page. The interests section includes questions and categories of interests (saved in a database), such as websites 145 to add to the user's webtop 135 at the website of the invention, music, hobbies, and the like. In an example, the user selects the LinkedIn® website and Groupon® website to add to his webtop. A user can create an interest category if not listed in the database and the new interest will be added to the database.

The Profile module 30 includes an interface to input authentication information for third-party websites 145. Based on the information, the Profile module authenticates the user to third-party websites. The Profile module has 3D facial and physical recognition for creation of the Avatar. The Profile module creates a search index database for individual search indexing. (e.g., every search done by a user is saved in a Profile database 230 instead of global index). The Profile module has a different interface and dashboard for business users than that of individual users. The Profile module saves the information, image data, chosen categories and interests, URL's, etc., into each user's profile file in the database 230 on a profile server at the module 30 and creates a webtop 135 specific to the user.

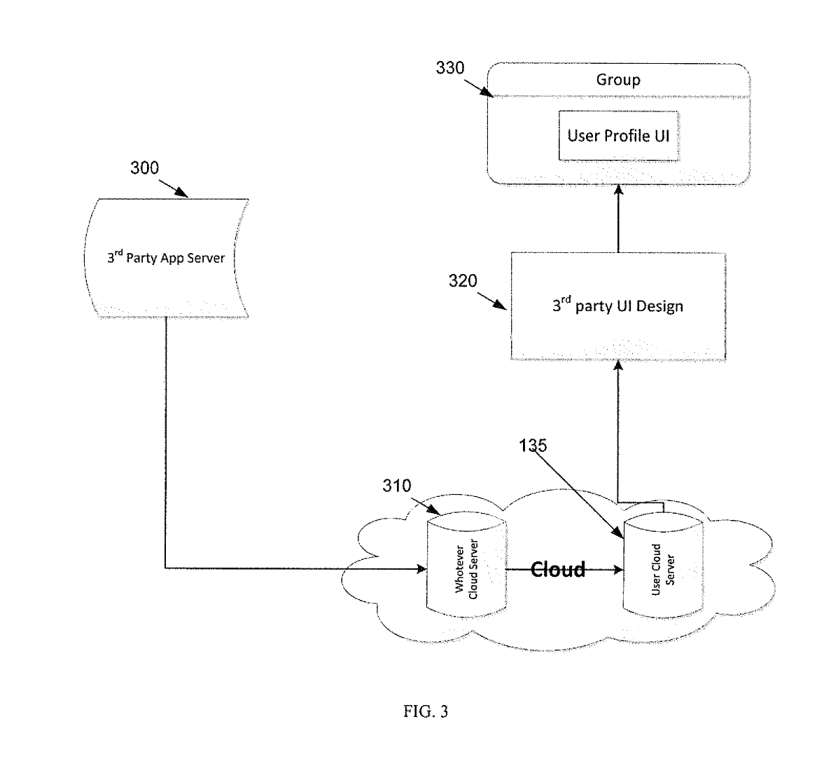

As depicted in FIG. 3, the system stores interface designs of applications of third parties 300 selected by a user on a system server 310 and a user profile 135. The system modifies the interface (Apple® or Windows®) using interface standards to create a user interface design 320 that look consistent with other interfaces of the user (for example, a double-click on items in one list has the same action items in any other list). Items that are logically connected are grouped 330 together on the screen to communicate they are connected.

The system includes a grouping feature that generates and maintains groups. A new group definition may be generated manually by the user, automatically by the grouping feature according to a dimension, and/or automatically by the grouping feature according to a common characteristic shared among items in the group (electronics, cars, handymen, professional services, etc.). In this manner, the user may identify and manage groups according to one or more shared characteristic(s) that are common among a group. The grouping feature adds users to a group based on the method in which the group was created. For example, the user may identify a hobby, a career, an age range, and the like, and the grouping feature automatically adds the user to the specified group. Alternatively or additionally, the grouping feature asks the user which groups the user would like to join. Thus, the grouping feature may be used to easily add users to various groups, which enables the user to interact with other users on a group level. An advertiser may identify or otherwise select a group.

Once a group has been identified or otherwise selected, the advertiser may perform subsequent actions for the selected group. Subsequent actions may include sending a group message, sending the members of the group literature on a topic, and/or perform other action suitable for a group. For example, the advertiser may select a “gardener” group, and send a group message that a non-toxic insecticide for tomatoes is currently available. In another example, the advertiser may select the “attorney” group and send the group literature that includes relevant information for malpractice insurance. In this manner, the grouping feature is used to perform actions on a group of users that would otherwise be redundantly performed for each in the group on an individual basis.

The system provides assistance to the user in managing websites for the user's webtop. The webtop integrates with one or more third-party websites in order provide a portal to each for direct access by the user. For example, a user may type in the URL of each website he wishes to include on the webtop. Alternatively, the user drags and drops an open web page onto the webtop. The system prompts the user for any usernames and passwords required to access the selected sites. The system stores the inputted information and provides secure connections to the selected sites.

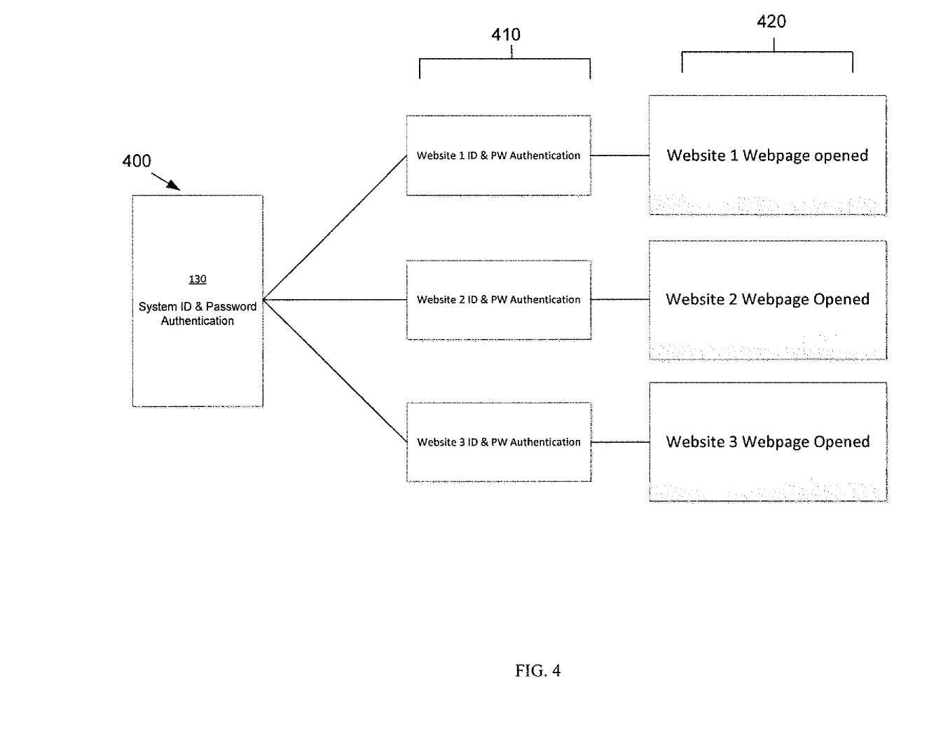

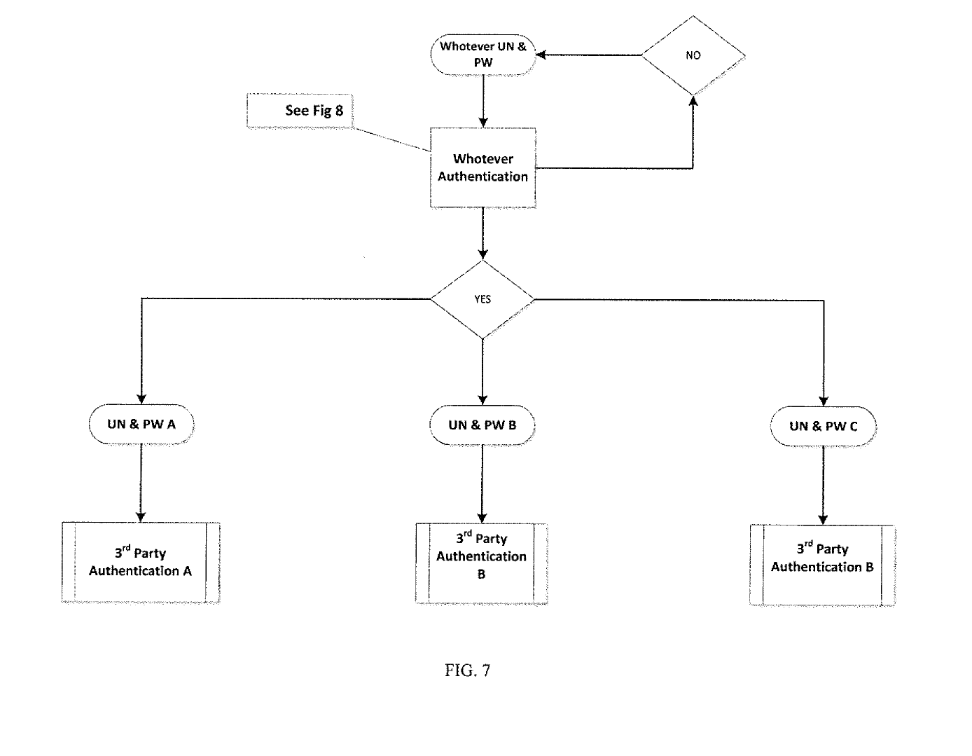

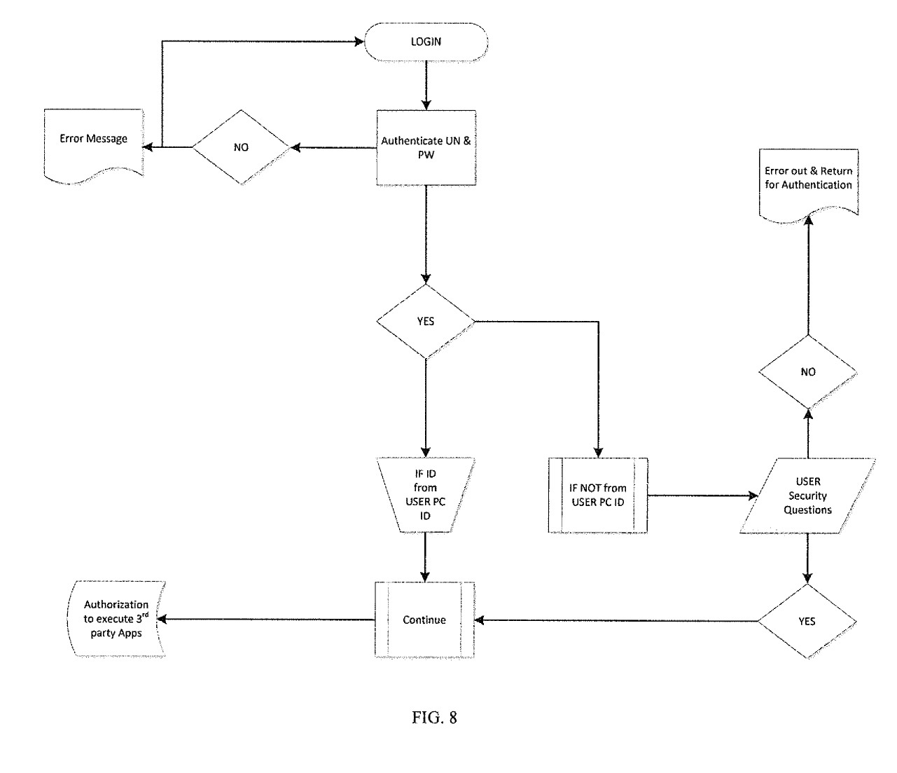

As shown in an embodiment depicted in FIG. 4, a user signs 400 on to the system by providing a system ID and password to access the website 130 and that user's webtop 135. According to an aspect of the invention, the Single Sign-On 40 module registers and recognizes all kinds of third-party authentication criteria. The Single Sign-On module may give users choices to create security questions for system log-in. The Single Sign-On module saves all of the user's third-party usernames and passwords to a Profile authentication database. The Single Sign-On module includes the ability for voice recognition, facial recognition, and eye print verification. In an embodiment, the invention provides sign-on session management by establishing a session credential and validating the session credential 410 at the third-party site. In this embodiment, the user is authorized to the third-party server by establishing a session credential stored in the user's profile. The system validates the session credential using a session management plug-in and grants access to the third-party website 420. The Single Sign-On module comprises means to continually/timely update a secure site to avoid authentication time out. Detail of the authentication step is provided in FIGS. 7 and 8.

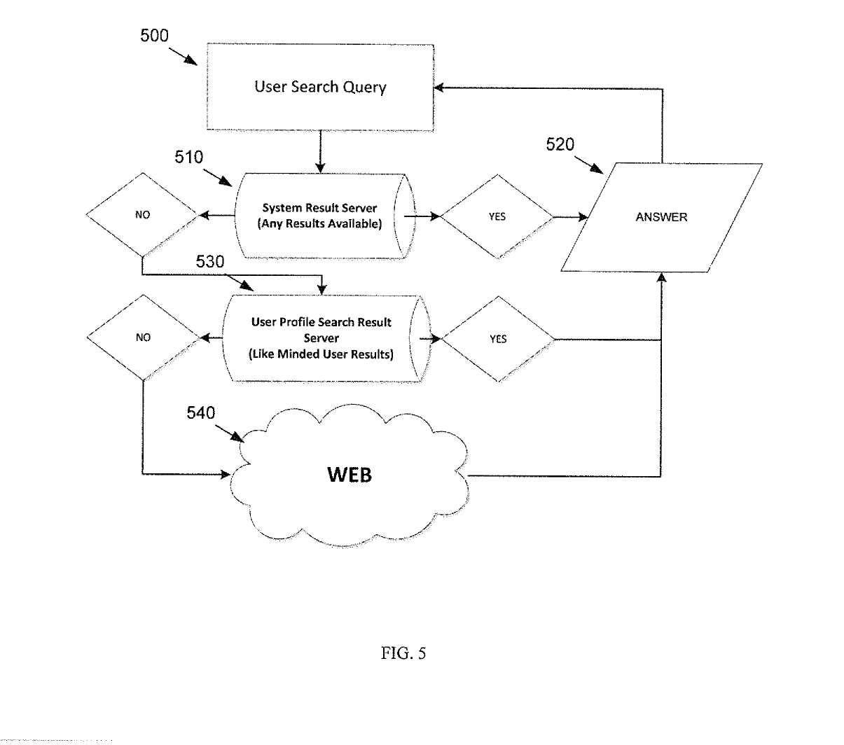

Referring to FIG. 5, a user uses the system's search engine to discover, organize and share information. The search module comprises search engines, databases and related software and components. In response to a user's inputted search query 500, the search module first checks a database of stored information located on the system 510. If the answer to the query is located in the system database, the answer 520 is posted at the user's webtop (notification may also be sent to the user, such as to an email box, a text message, Skype® message and the like). If no answer is found in the system database, the search module checks a database of stored information of users having similar interests 530 stored on the system. According to an aspect of the invention, the Discover Decision Engine 50 module analyzes user interests and searches other user profiles for similar interest results. The Discover Decision Engine module sends similar interests results to users as suggestions. If the answer to the query is located in the like-minded users' database, the answer 520 is sent to the user (with the option to link to the like-minded user). If no answer is found in the like-minded database, the search module checks the Internet 540. Possible answers discovered are posted to the user.

The Discover Decision Engine module analyzes status and input by users and gives suggestions based on queries. The Discover Decision Engine module includes a time capsule for searches so that each search expires over a period of time (controlled by the user). The Discover Decision Engine module searches all file types (e.g., text, video, pictures, website, audio, etc.).

The search module enables a user to search for “like-minded” users by group, by dimension, or individually. The search module is used by users to perform queries. The search engine first searches a query database for responses to the query, and then searches the Internet if the response is not found. The system stores responses found on the Internet in the query database. The query database is a multi-dimensional contextual database for storing prior search queries and other information. The system may incorporate or otherwise use information from the multi-dimensional contextual database, third-party repositories, and/or other sources of information. Data may include, among other things, any webpage that offers a service or product that a user has expressed interest in. Information elements that contextually form part of the data include data from the user, and/or any other information associated with the user, the product, service, provider, location, etc. An information element may be viewed in multi-dimensional contexts. For example, when viewed in the context of a query as to the best convertible car to purchase, all answers to queries related to rankings for automobiles may be displayed among other answers similar to the query. When the query answer is viewed in the context of a dimension for a particular brand of car, only the query answers for “BMW” may be displayed. As a further example, when query answers to the “best convertible” question are viewed in the context of dealer dimension, local car lots may be displayed. Thus, by providing a multi-dimensional view of information from the database, information may be viewed according to the context in which the information is presented. An information element may be linked to another information element. For example, an information element “convertible” may be linked to another information element “country of origin” such that the car is linked to the country in which the car was made. In turn, “country of origin” may be linked to an information element “all autos”, for example, such that a user can research all cars from a certain country. In this manner, the database provides comprehensive information on which queries and analyses may be generated and performed. An information element may be categorized into an information element category. For example, a query for a flat screen TV may be categorized as an “electronic” category. In this manner, information elements may be viewed in the context of similar information elements and grouped accordingly, thereby helping the user to organize information from a record.

The Discover Decision Engine provides results based on the user's profile (including business type, interests, websites identified and the like). The Discover Decision Engine accesses the profile to obtain any updates. The Discovery Decision Engine organizes the users interests, and creates “buckets” based on the user profile (e.g. if user interest is “country--> Taylor Swift” music, then the Discover Decision Engine adds new music automatically/optional to its bucket. Optionally, the new music is placed into a possible interest bucket until discarded. The Discover Decision Engine manages and organizes files and applications, integrates with social and email messaging, organizes stored searches and updates based on preferences, and managed advertisements based on the user's profile and also marketing of ads from other profiles.

Upon login, the Discover Decision Engine provides suggestions of new interests to the user. The Discover Decision Engine offers links to like-minded users (organize and share engines also involved), and will match search queries with profile interests and give suggestions.

In an embodiment, the cloud-based search engine provides clustering and organizing of a set of observations having similar attributes into subsets. The search engine includes algorithms for optimization of searches and a decision tree providing a predictive model that maps similar data. Algorithms, as those used in the computer science arts, are sequence of steps leading to a desired result. The algorithms process input piece-by-piece in a serial fashion to extract a pattern from existing and additional data.

In an embodiment, the system utilizes support vector machines to analyze data and recognize patterns. To search for information associated with the system, the user uses the search module to search for information. The search module may auto-complete search terms (such as letters, words, numbers, etc.) as the search terms are being received. According to an aspect of the invention, information identified by search results may be highlighted in the display. Highlighting may include enlarging, coloring differently, or otherwise altering the appearance of information in a search results display.

According to an aspect of the invention, highlighted information in a set of displayed search results may be selected for further processing. For example, clicking on (or otherwise selecting) an item may result in a preview display of the information. Upon selecting a result to view, the user may use a module to interact with a multi-dimensional contextual display of the information. The module may display one or more focal points of interest around which information related to the focal point may be arranged. Depending on the focal point and the context in which the focal point is displayed, information that may be displayed around the focal point may vary.

According to an aspect of the invention, the Semantic Search 100 module uses profile interests to filter through web index and ranks results based on full query and not words in the query. The Semantic Search gives results based on interests and not just what it finds. It searches like-minded user interest results before searching web. It has a dictionary and understanding of sentences in many languages. It has the ability to search based on location.

According to an aspect of the invention, the user may refine information discovered in a search by adaptively analyzing the information. The refine module continuously integrates new information in order to answer a question posed by the user. The information may originate from the data stored in the system or at third-party repositories. The refine module adapts answers based on input from the user and/or based on information that has been added since a similar answer was provided. As the information regarding the question progresses, the refine module adaptively makes suggestions based on new information.

The Organize Interests module 60 communicates with the profile servers to automatically organize users' interests. The Organize Decision Engine adds websites into a user's webtop based on search requests. The Organize Decision Engine adjusts the statistic on the dashboard for a website posted as to avoid duplicates. Organize Decision Engine captures new unsorted interests and sorts them into buckets based on type. If no bucket exists for the interest, the system prompts the user to provide a suggested name for the bucket.

The Organize Interests module 60 communicates with profile server to automatically organize cloud services. The organize interests engine identifies file type being uploaded based on profile settings. If the file type (file extension) is not available, the organize interests engine searches the Internet for a plug-ins. The organize interests engine obtains any application licenses and adds the application to the identified bucket.

According to an aspect of the invention, the Organize Interest 60 module gives users the option to categorize interests and the ability to create new categories of interests. The Organize Interest module allows users to save newly accepted suggestions to a different or newly created category. The Organize Interest module provides the ability to organize like-minded users in a group by interests and gives users the option to choose such groups. The Organize Interest module groups consumers and businesses based on their interests. The Organize Interest module moves categories to different folders and edits newly created categories.

The Share Interest module 70 comprises a share decision engine. A user has the option to share interests, search queries and results (consumer/business) with like-minded users. Businesses can target company information, product and events to users who have searched for a product related or sold by that business. The Share module 60 allows a user to share personal files with other users. A Share Decision Engine receives updates from profiles and queries for like-minded users. The Share module prompts the user to see if the user is interested in adding new users, websites, application, etc. Based on an affirmative response, the Share module adds selected interests, search queries and results to the user's webtop.

According to an aspect of the invention, the Share Interests 70 module allows information sharing between allowed users or businesses. The Share Interests module provides a default question of sharing information if the user has not made a share decision. The Share Interests module displays requests for information before sending. The Share Interests module shares user information among different social networks. The Share Interests module allows a user to choose from a status update as to what groups to share information with.

The search engine includes a refine module that continuously integrates information in order to generate better search results. The refine module may adapt suggestions based on input from the user refining the suggestions and/or based on information that has been added since a search was made.

According to an aspect of the invention, when a search result is available, the user may view the result, which may include advertisements. An Ad Filter (discussed below) allows the user to designate ads the user wishes to view.

in order to manage existing search, find new information, and like-minded users, the system may provide the user with access to ratings from others using the system or ratings available on the Internet. A user may tag a particular information element and/or information element category. For example, a user may tag a particular search result as “flat screen TV” such that subsequent searches for the tag reveal similar products. In this manner, the search module may be used to review various results highlighted by category.

According to an aspect of the invention, the Cloud 80 module downloads, uploads and runs full software applications. The Cloud module has the ability to use browser plugins for applications (e.g., camera usage for Skype® or gaming). The Cloud module gets updates from third-party applications. The Cloud module includes the third-party authentication for security and single sign-on for each user. The Cloud module is adaptable for AGPS/WiFi for geo-location. The Cloud module uploads files of all extensions.

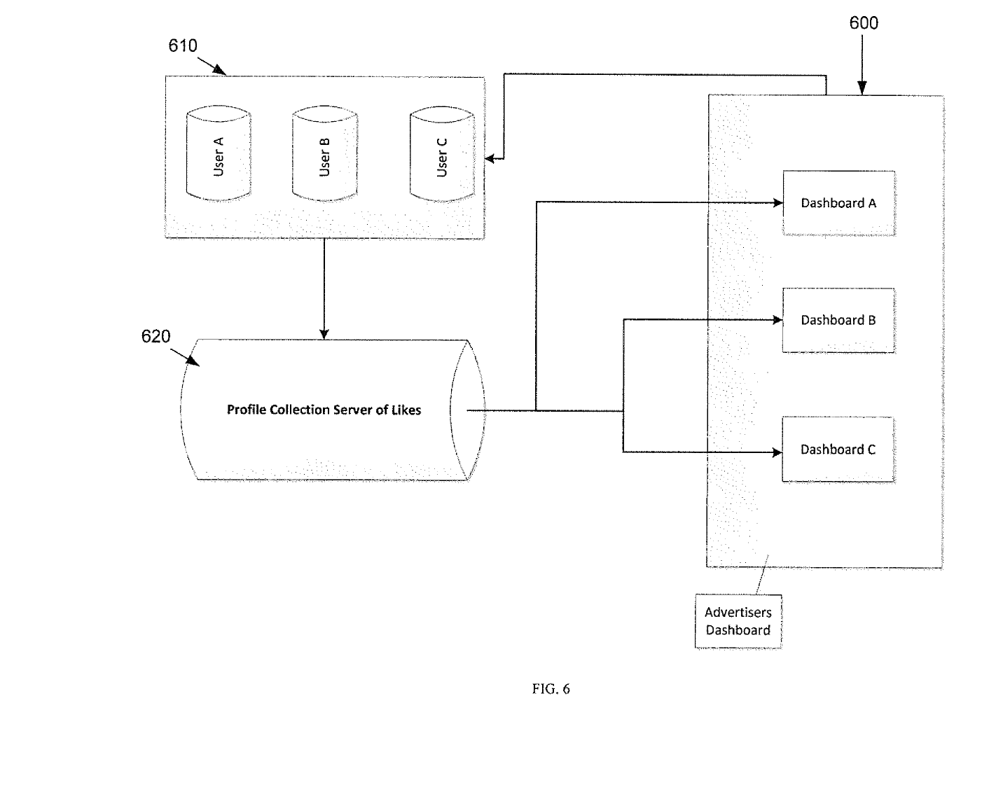

According to an aspect of the invention, FIG. 6 illustrates a block diagram showing an example of three companies each having a dashboard. The companies provide advertising on the dashboards of users based on metric analytics of the Profiles. The advertising can be specified for given segments of time and timeframes, such as periods, holidays, times, periodic, etc. Advertisers can base advertising on what user want and provide cross-selling to other brand users. Users can share advertising information that appears on their dashboard. A user can selectively block advertisements.

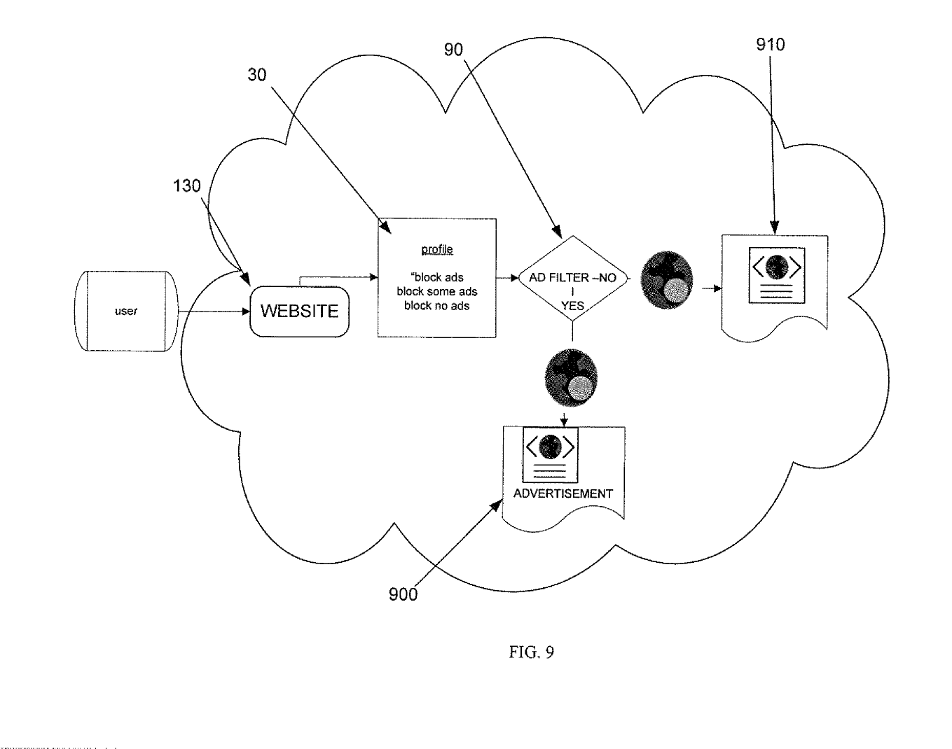

As depicted in the diagram shown in FIG. 9, the Ad Filter 90 module blocks website/application advertisements, and collects ad-company info to ad servers. A user accesses the website 130 and inputs information at the Profile module 30 to specify particular advertising content that is to be excluded from websites on his/her webtop. The Ad Filter module 90 produces an ad tag, which request and selects advertising content. The user then sees desired ads 900 and undesired ads 910 are screened from the websites. The Ad Filter identifies user's interests from searches and gives businesses the ability to advertise to users (see FIG. 6).

According to an aspect of the invention, the Security 110 module comprises interaction with hardware of choice for regular access; questions produced by each user for access via third-party hardware; a camera/fingerprint reader from hardware for the secure login; the ability to save third-party website security criteria for future log-in authentication; the ability for each user to choose time-out session for private website/information when on third-party hardware or personal hardware; voice recognition for security login; and the ability to disallow dual login.

The Communications module 115 of the system, among other things, facilitates users' online communication, which may be in real-time. Online communication may include, for example, instant message, online comments, voice conference, video conference, and the like. Communications may include, among other things, general emails, updates from advertisers, notifications regarding query results, and the like. A user receives notifications or communications at the webtop, which may include messages from advertisers regarding upcoming promotions or information about a product/service/merchant recently queried by the user. For example, a user may receive a notification that the query answer is available in the query database. If the answer is not available in the database, the search tool searches the Internet and provides links to possible answers to the query. The system notifies an advertiser located at the link when the user selects a link related to the advertiser. By providing an integrated interface to various communications, the system enables the user to make informed decisions based on information as it becomes available in real-time.

The Communications module may comprise instant-messaging (chat), SMS, e-mail, voice conferencing, video conferencing, web forms, and/or other communications techniques. The user may use the Communications module 115 in order to, among other things, receive reminders, view search results, and locate businesses.

According to an aspect of the invention, FIG. 6 illustrates a block diagram showing an example of three companies (A, B, C) 600 each having a dashboard. The companies provide advertising on the dashboards of users (A, B, C) 610 based on metric analytics of the Profiles. The advertizing can be specified for given segments of time and timeframes, such as periods, holidays, times, periodic, etc. Advertisers can base advertising on what users want and provide cross-selling to other brand users. Users can share advertising information that appears on their dashboard. A user can selectively block advertisements as provided above in the Ad Filter module.

Based on search queries, the Organize Interests module 60 organizes the users' interests into buckets at the Profile database. The Organize Interests module 60 communicates with profile server to create a collection of user groups based on their interests 620. The system communicates the collections to companies 600 to provide advertising on that company's dashboards targeted to users 610 based on their interests.

The following examples are provided to illustrate the system:

### Example 1

Create Profile

A new user goes to the site to create a profile by typing first name, last name, username, password, email, avatar, location, marital status, occupation, hobbies, interests (games, music, websites, books, applications, etc.), categories of interests (pop music, board games, news websites, programming applications, comic books, etc.), security for personal interests above (credentials for social sites, credentials for financial websites, credentials for applications, credentials for cloud databases etc.).

In the background, the Discover Decision Engine (DDE) matches the user with other like-minded users with similar interests. Users can send invites to add to their group.

Users update their statuses on a daily basis. This container can be filled will interests, search queries, etc. This container will be very adaptive and sensitive to the query put in by the user. For example, if a user says “I'm tired”, the statement is shared on social sites. If a user says “looking for a 3 bedroom apartment”, this now becomes a search query.

Discover

An existing user (consumer) logs into his/her profile to search for a 3 bedroom apartment. The Discover Decision Engine (DDE) searches the profile servers, including business profiles, first for this query. At the same time that this query is sent, another user (business) receives the query that a consumer is looking for a 3 bedroom apartment. If it matches exactly, meaning 3 bedroom apartments based on the user's profile (city, state, type, status, etc. . . . ), the result is sent to the user's page. If it does not match, the query is sent to the web to find exact results and send to user's page. If there is a match on the web, send results to the user's page but also send an inquiry to the business about who is searching for them. An algorithm will search for the new business' email and send an inquiry to the business about people searching for them. The business will encourage them to join the site for advertising. An email inquiry is only sent after a certain amount of searches are done on the business. Example, send an email per week.

If there is no exact match from the web, then return “NO MATCH FOUND” and display alternative suggestions. If no alternative suggestions are picked, store original query for recurring searches. Recurring searches will happen every day in the background until the result is found.

### Example 2

Create Profile

A male college student looking for a 3 bedroom apartment goes to the site to create a profile. He enters his first name, last name, username, password, email, avatar, location, gender, hobbies, interests and occupation. The user also creates a category called “School” where his school information is placed. He then adds “looking for a three bedroom apartment” to his status bar. A new user goes to the site to create a profile by typing first name, last name, username, password, email, avatar, location, marital status, occupation, hobbies, interests (games, music, websites, books, applications, etc.), categories of interests (pop music, board games, news websites, programming applications, comic books, etc.), and security for personal interests above (credentials for social sites, credentials for financial websites, credentials for applications, credentials for cloud databases etc.).

In the background, the Discover Decision Engine (DDE) matches the user with other like-minded users with similar interests. Users can then send invites to add others to their group.

A new business, ACME Apartments, creates a profile by entering their business name, address, logo, list of services and products, category of business, type of business, email, EIN number, and account information. ACME apartments updates their status with top deals on three bedroom apartments for the month. If there are no business profiles matching the search query in our consumer profile server, the algorithm will search the web for matching profiles and send an email to have the matching business create a profile at the site.

Discover

The college student receives an advertisement from ACME Apartments about the 3 bedroom apartment on his dashboard. He also gets suggestions from like-minded users about their experiences with ACME Apartments and their 3 bedrooms apartment. Discover Decision Engine (DDE) searches the profiles servers, including business profiles, first for this query. At the same time this query is sent, another user (business) receives the query that a consumer is looking for a 3 bedroom apartment. If it matches exactly, meaning 3 bedroom apartments based on the user's profile (city, state, type, status, etc.), the result is sent to the user's page. If it does not match, the query is sent to web to find exact results and send it to the user's page.

If there is a match on the web, send results to the user's page but also send an inquiry to the business about who is searching for them. Here, the algorithm will search for the new business's email and send an inquiry to the business about people searching for them. The business will encourage them to join the site for advertising. An email inquiry is only sent after a certain amount of searches are done on the business. Example, send an email per week.

If there is no exact match from the web, then return “NO MATCH FOUND” and display alternative suggestions. If no alternative suggestions are picked, store original query for recurring searches. Recurring searches will happen periodically in the background until the result is found.

Organize

The college student chooses ACME Apartments as his best selection. The business receives notification that this college student has chosen them. The Organize Decision Engine (ODE) adds the ACME website into the consumer's bucket called “Apartment”. The ODE adjusts the statistic on the dashboard for ACME Apartments so they do not have to repeat the advertisement to the same customer.

Share

The college student updates his profile about the new 3 bedroom apartment he moved into. The Share Decision Engine (SDE) shares the status with like-minded users also looking for 3 bedroom apartments.

The business also receives the status update from the college student on how he likes his apartment. ACME apartments shares the rating with like-minded users.

The Cloud

A female college student is looking to use Microsoft word, and already has 2 TB of space available on her profile server. Microsoft receives notification for Word. She is sent an Ad to get Microsoft office suite at an online price. She then buys and downloads the software to her profile server. All documents on her laptop are now downloaded to her document folder on her profile server.

### Example 3

A gamer is interested in playing God of War and updates status of this interest. A game developer receives this notification and sends an ad for availability to access the profile server to connect to the game. The gamer buys an instance to access the game and can play directly from the browser. Peripherals needed to play the game are also advertised by the accessory manufacturers. The gamer can now play the game directly from any Internet-capable device with a browser.

Examples of the method include:

User goes to the website (Consumer/Business). The user has 3 possibilities:
a. Sign Up—create profile
b. Log in—update profile
c. Search and Surf explore website

Sign UP (1a)

In this step the user will create a profile.
Creating a Profile: If the user is a business, then create a business profile. If the user is a consumer, then create a consumer profile.
In Consumer profile: create unique ID, add personal information, add interests (includes websites with usernames and passwords). **Note: Unique ID is used to access all other IDs in a user's profile.
In Business profile: create Unique ID, add business information, including billing, product and services, etc. **Note: Unique ID under business profile is used to access all other businesses.
If user does not sign in, they can go home and explore website (the site).
If user has previously created a profile, then move to step 1b.

Log In (1b)

In this step the user inputs username and password. This opens an array of options: from updated interests to newly found interests based on the user preference.
Discover Decision Engine (dDE) picks up unique ID, verifies and logs into other interests
If user is verified, user logs into other profile interests
(dDE) updates existing user's other interests automatically
(dDE) gives suggestions of new interests to user
(dDE) sync's with like-minded users (also organize and share engine)
(dDE) will match search queries with profile interests and give suggestions
If user is not verified, the user is prompted with security questions
If confirmed, execute (1bi)
Else go back to home page (step 1) to sign in as new user.

If user does not log in, they can go home and explore website (the site).

Organize (Step 2)
Communicate with profile servers to automatically organize users' interests.

The Organize Decision Engine (ODE) adds the ACME website into the consumer's bucket called “Apartment”. The ODE adjusts the statistic on the dashboard for ACME Apartments so they do not have to repeat.

Organize Decision Engine (ODE) captures new unsorted interests.
If unsorted found, go to step (ii)
If no unsorted interests report none and return to step (i)
ODE sorts interests into its type buckets
If type bucket not available, request suggestion
If type bucket available, add interest
ODE picks up accepted suggested interests from dDE
If query equals accepted go to step (ii), else step (iv)
ODE adds dDE suggested interest to type buckets
Communicate with user storage server and automatically organize cloud services
ODE identifies file type being uploaded based on profile settings
If file type (file extension) not available, ODE search web for plugins.
If file type (file extension) available, move to step (ii)
ODE adds files to type buckets
If file type is application, move to step (iii), else return to step (i)
ODE picks up newly downloaded applications from dDE and identifies type
If application is from external source, then get license instance
If application license not needed (e.g. free), then install
If application not from external source, then get license request
If application license not needed, then install
ODE adds applications to type buckets

Share (Step 3)

Interest, search queries are shared with like-minded users (consumer/business)

a. Share Decision Engine (sDE) gets the updates from profiles and queries for like-minded users in the system of the intention.
If user is interested in adding new users, websites, application etc.; add them,
Else return to (a)

b. sDE will push business interests to like-minded users
If users are found, return results (advertisers) to businesses
If business wants to advertise, go to iii, else go to b)
Advertise to users/customers

c. Cloud:
sDE gets user files/applications to be shared from user bucket
If accepted users available, then send files/application
If no accepted user, return to bucket.

Aspects and implementations described herein, such as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other aspects or implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

1. A computer implemented method of providing a single secure site for a user to discover, access, view and manage a plurality of resources on a device connected to a network, comprising the steps of:
a) receiving and updateably storing at a server after a successful sign-on to the site by the user, user information from a remote terminal connected to the server via the network, the user information comprising at least one of a user webpage, an authentication related to the user for a given webpage, a demographic, an interest, and a query;
b) providing a decision engine that offers resources to the user based on the user information;
c) creating and storing a list at the server of updateable resources based on the user information and selected decision engine offers; the resources being at least one of the user's designated webpages, a targeted webpage, an application, a query answer and software;
d) opening and establishing secure sessions to the resources accessible from the remote that allow the user to access the resources without a second sign-on and wherein each resource is viewed directly by the user on a single webtop and not reopened in a different tab;
e) making any add-ons required to view resources available to the device; and
f) providing means for a user to share resources with other like-minded users.

2. The method of claim 1 wherein the resources are at least one of a social, a shopping, a banking, an electronic transfer, a media and an entertainment web site.

3. The method of claim 1 wherein the server is a cloud server.

4. The method of claim 1 wherein the means for a user to share information is via at least one of a blog, a text message and an email.

5. The method of claim 4 wherein the site provides a combined inbox of all emails used by a user at the remote terminal.

6. The method of claim 1 wherein the decision engine ranks offers by categories prior to display at the remote terminal.

7. The method of claim 6 wherein the categories are at least one of a hobby, a lifestyle, food, animals, careers, health, sports, and the like.

8. The method of claim 1 wherein the user information is stored in a profile associated with the user.

9. The method of claim 8 wherein the profile is updateable by the user.

10. The method of claim 1 wherein the user information is a query and the site provides means for the user to set a time limit for the query.

11. The method of claim 3 wherein the resources are housed in a second cloud.

12. The method of claim 1 wherein the user information comprises a digital image of the user, the resource is an online shopping site and the query is at least one of a fashion style or a cosmetic that is compatible with at least one element of the digital image.

13. The method of claim 12 wherein the digital image is a 3D image.

14. The method of claim 1 wherein the websites are filtered by a mechanism that identifies advertising content provided in the website and removes the content prior to display at the remote terminal.

15. An apparatus for providing a single secure site for a user to access, view and manage a plurality of resources on a network, said apparatus comprising: a network interface configured to communicate with a plurality of websites; a storage apparatus; and a digital processor containing programs which, when executed:
a) receive and updateably store at a server after a successful sign-on to the site by the user, user information from a remote terminal connected to the server via the network, the user information comprising at least one of a user webpage, an authentication related to the user for a given webpage, a demographic, an interest, and a query;
b) provide a decision engine that offers resources to the user based on the user information;
c) creates and stores a list at the server of updateable resources based on the user information and selected decision engine offers; the resources being at least one of the user's webpages, a targeted webpage, an application, a query answer and software;
d) opens and establishes secure sessions to the resources accessible from the remote terminal that allow the user to access the resources without a second sign-on and wherein each resource is viewed directly by the user on a single webtop and not reopened in a different tab;
e) makes any add-ons required to view resources available to the device; and
f) provides means for a user to share resources with other like-minded users.

16. The apparatus of claim 15 wherein the decision engine ranks offers by categories prior to display at the remote terminal.

17. The apparatus of claim 15 wherein the websites are filtered by a mechanism that identifies advertising content provided in the website and removes the content prior to display at the remote terminal.
